(19) United States
(12) Patent Application Publication
(10) Pub. No.: US 2020/0003306 A1
(43) Pub. Date: Jan. 2, 2020

(54) Anti-Rotational Piston Pin Retention Button

(71) Applicant: Race Winning Brands, Inc., Mentor, OH (US)

(72) Inventors: Gregory Turkall, Mentor, OH (US); Matthew Newman, Seven Hills, OH (US); Jacob W. Balsiger, Mentor, OH (US); Cody Lyle Mayer, Chicago, IL (US); James Keith McWilliams, Kirkland, OH (US)

(73) Assignee: Race Winning Brands, Inc., Mentor, OH (US)

(21) Appl. No.: 16/569,844

(22) Filed: Sep. 13, 2019

Related U.S. Application Data
(63) Continuation-in-part of application No. 15/873,106, filed on Jan. 17, 2018.
(60) Provisional application No. 62/768,246, filed on Nov. 16, 2018.
(60) Provisional application No. 62/447,061, filed on Jan. 17, 2017.

(51) Int. Cl. F16J 1/18

(52) U.S. Cl. CPC F16J 1/18

(57) ABSTRACT

An improved piston pin retention button device having a body portion comprised of both a generally cylindrical portion and a surface, such as a planar surface, for mating engagement with a corresponding surface formed in a piston device. The inclusion of both the surface on the body portion and the corresponding surface in said piston device prevent rotation of the button device in the piston device. Other embodiments of a piston pin retention button device are also disclosed and prevent the unwanted rotation of the button device in the piston device, and permit the oil ring to function as designed.

### CROSS-REFERENCE TO RELATED APPLICATIONS

The present application claims priority from all of the following which are incorporated herein by reference in their entirety: (a) U.S. Provisional Patent Application Ser. No. 62/768,246 filed on Nov. 16, 2018, and (b) U.S. Non-provisional patent application Ser. No. 15/873,106 filed on Jan. 17, 2018 which, in turn, claims priority from U.S. Provisional Patent Application Ser. No. 62/447,061 filed on Jan. 17, 2017.

### FIELD OF THE INVENTION

This invention pertains generally to an improved piston pin retention device or button that prohibits rotation of said button in a piston bore.

### BACKGROUND

Piston pin retention buttons are used to support the oil ring assembly and give it longer life, which is both advantageous, particularly in a competitive racing environment, and desirable. Standard piston pin retention buttons are generally cylindrical in shape and usually have a notch or oil ring groove cut out to accommodate the presence of the oil ring. Unfortunately, with this type of design, the standard piston pin retention buttons have a tendency to rotate within the piston pin opening or bore, thereby causing the oil ring to become pinched between the piston pin retention button and oil ring groove. This may result in a lack of oil control in the piston cylinder, and decreased life and/or premature failure of the oil ring and/or the piston, all of which are undesirable and can be expensive to repair or replace.

Consequently, there exists a long felt need in the art for a piston pin retention button that does not rotate within the piston bore. There is also a long felt need in the art for a piston pin retention button that permits a proper level of oil control in the piston cylinder and that doesn't result in premature failure of the oil ring and/or the piston. Finally, there is a long felt need in the art for a piston pin retention button that accomplishes all of the forgoing objectives, and that is relatively inexpensive to manufacture and safe and easy to use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a piston pin retention button device comprised of a body portion and at least one locating tab extending outwardly from said body portion for mating engagement with a corresponding tab cutaway or opening formed in the piston. Once said locating tab matingly engages the corresponding tab cutaway formed in the piston, rotation of the piston pin retention button device is prohibited and the oil ring is permitted to function as originally intended.

In an alternative embodiment of the present invention, the piston pin retention button device is comprised of a body portion and a fastener, such as a set screw, that may be threaded through the piston wall to tighten against the piston pin, which may be comprised of a relatively flat receiving surface or threaded opening. In this manner, unwanted rotation of the piston pin retention button can be prevented, and the oil ring is permitted to function as originally intended.

In a further alternative embodiment of the present invention, both the piston pin retention button device and the piston may each comprise a receiving groove for receipt of a key, such as a woodruff key, to prevent unwanted rotation of the piston pin retention button device. The size, shape and orientation of the key could vary to suit user preference and/or need, as long as it prevents unwanted rotation of the piston pin retention button device.

In yet another embodiment of the present invention, the outside or second end of the piston pin retention button device may be manufactured in a non-cylindrical shape (e.g., an oval, square, rectangle, etc.) with a corresponding mating opening in the piston that is axially aligned with the piston bore. The piston bore would still preferably be generally cylindrical in shape to accept the first end of the piston pin retention button device, but the counter-bore for the button would have a shape that would prevent unwanted rotation of the piston pin retention button device.

The foregoing has outlined the more pertinent and important features of the present invention in order that the detailed description of the invention that follows may be better understood, and the present contributions to the art may be more fully appreciated. It is of course not possible to describe every conceivable combination of components and/or methodologies, but one of ordinary skill in the art may recognize that many further combinations or permutations are possible. Accordingly, the novel architecture described below is intended to embrace all such alterations, modifications, and variations that fall within the spirit and scope of the appended claims.

There has thus been outlined, rather broadly, the more important features of the anti-rotational piston pin retention button device in order that the detailed description thereof that follows may be better understood, and in order that the present contribution to the art may be better appreciated. There are additional features of the invention that will be described hereinafter and which will form the subject matter of the claims appended hereto.

In this respect, before explaining the various embodiments of the invention in detail, it is to be understood that the present invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 is a rear elevational view of one embodiment of the piston pin retention button device of the present invention.

FIG. 2 is a rear perspective view of the piston pin retention button device of FIG. 1.

FIG. 3 is a front elevational view of a piston device with cutaways shown and ready to receive the piston pin retention button device of FIG. 1.

FIG. 4 is a perspective view of a piston device with the piston pin retention button device of FIG. 1 exploded out therefrom.

FIG. 5 is a bottom perspective and partially exploded view of a piston device and an alternative embodiment of a piston pin retention device of the present invention.

FIG. 6A is a perspective and partially exploded view of a piston device and a further alternative embodiment of a piston pin retention device of the present invention.

FIG. 6B is a perspective and partially exploded view of the piston device and piston pin retention device of FIG. 6A.

FIG. 7A is a perspective and partially exploded view of a piston device and yet another alternative embodiment of a piston pin retention device of the present invention.

FIG. 7B is a perspective view of the piston device of FIG. 7A ready to receive the piston pin retention device depicted in FIGS. 7A and 7C.

FIG. 7C is a rear elevational view of the piston pin retention device of FIG. 7A.

FIG. 8A is a perspective and partially exploded view of a piston device and an additional alternative embodiment of a piston pin retention device of the present invention.

FIG. 8B is a front elevational view of the piston device of FIG. 8A ready to receive the piston pin retention device depicted in FIGS. 8A, 8C and 8D.

FIG. 8C is a perspective view of the piston pin retention device of FIG. 8A.

FIG. 8D is a front elevational view of the piston pin retention device of FIG. 8A.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

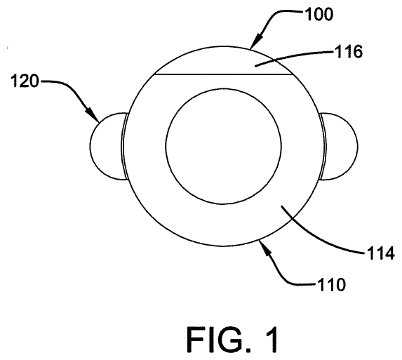

In each of the following described alternative embodiments of the piston pin retention button device of the present invention, the button device is effectively prevented from unwanted rotation within the piston bore, which could lead to premature failure of the oil ring and/or the piston. Turning now to the drawings, FIG. 1 is a rear elevational view of one possible embodiment of the piston pin retention button device 100 of the present invention. Button device 100 is comprised of a body portion 110 and at least one, and preferably two, locating tabs 120. Body portion 110 is generally cylindrical in shape and comprised of a first end 112, a second end 114 and a notch or oil ring groove 116 formed in said second end 114 to accommodate the presence of an oil ring (not shown). Body portion 110 may be formed of any material commonly known in the art to be used for pistons and piston components such as aluminum, etc.

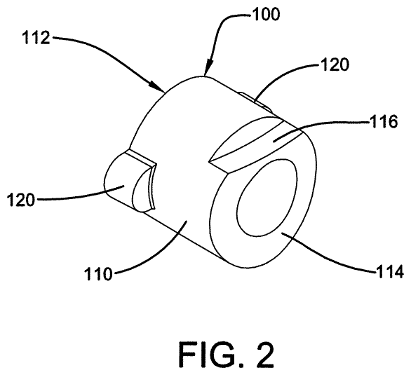

Locating tabs 120 are generally semi-cylindrical in shape (though it is contemplated that other shapes can be used as well without affecting the overall concept of the invention) and are attached to, or integrally formed with, body portion 110. More specifically, locating tabs 120 protrude outwardly from the outer surface of body portion 110, adjacent to first end 112 of body portion 110, as best shown in FIGS. 1 and 2.

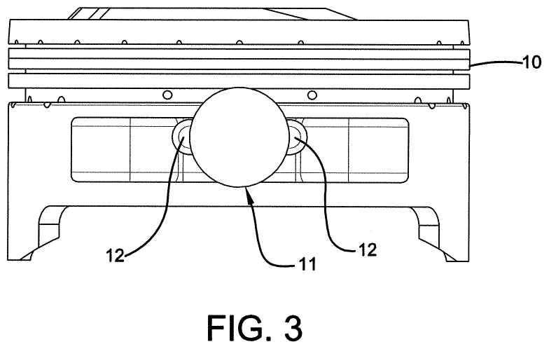

FIG. 3 is a front elevational view of a piston device 10 with the piston pin retention button device 100 of FIG. 1. More specifically, piston device 10 is comprised of a bore or opening 11 for receiving body portion 110 of button device 100 and one or more tab cutaways or openings 12 that are shaped and sized to accommodate the one or more locating tabs 120 of button device 100. Once said locating tab(s) 120 are matingly engaged with the corresponding tab cutaways 12 formed in piston device 10, rotation of the button device 100 within bore 11 and about its longitudinal axis (defined as the centerline of device 100 extending from said first end 112 to said second end 114 of body portion 100) is prohibited, and the oil ring (not shown) is permitted to operate as originally intended.

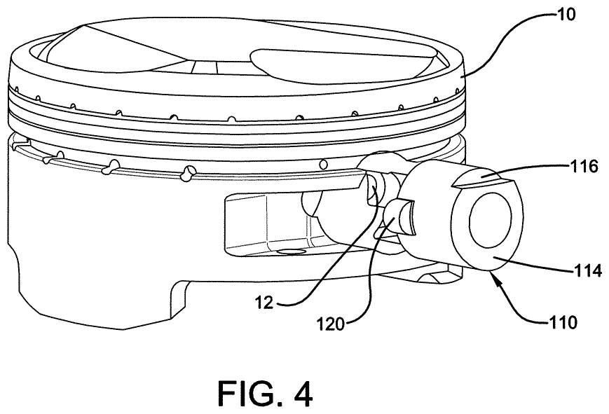

FIG. 4 is a perspective view of piston device 10 with the piston pin retention button device 100 of FIG. 1 exploded out therefrom. Importantly, the addition of locating tabs 120 on the exterior of body portion 110 limits the rotational freedom of the button device 100 within bore 11, and prevents the pinching of the oil ring (not shown) associated with prior art piston retention buttons, thereby permitting the oil ring to function as originally intended. As previously mentioned, prior art piston pin retention buttons have a tendency to rotate within the piston pin opening or bore, thereby causing the oil ring to become pinched between the piston pin retention button and oil ring groove. This may result in a lack of oil control in the piston cylinder, and decreased life and/or premature failure of the oil ring and/or the piston, all of which are undesirable and can be expensive to repair or replace. The device 100 of the present invention solves this problem.

Importantly, this embodiment of device 100 of the present invention can be sized and shaped to accommodate user preference and/or need, without impacting the overall concept of the present invention. Additionally, piston devices 10 that are manufactured to accommodate prior art piston pin retention buttons can be modified with tab cutaways 12 to accommodate the improved design described herein.

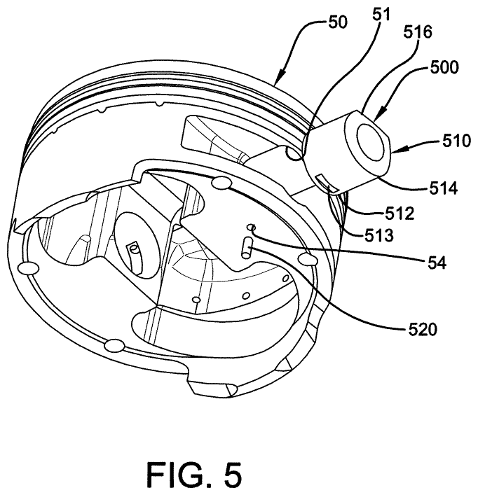

FIG. 5 is a bottom perspective and partially exploded view of a piston 50 and an alternative embodiment of a piston pin retention device 500 of the present invention. Piston 50 can be any piston commonly known in the art that comprises a bore 51 therein for receipt of piston pin retention device 500, but that further comprises an opening 54 that is generally perpendicular to said bore 51 for receipt of a pin or fastener, as explained more fully below. Opening 54 may be threaded or unthreaded.

Piston pin retention device 500 is preferably comprised of a body portion 510 and a fastener 520. Body portion 510 is generally cylindrical in shape and comprised of a first end 512, a second end 514, and a notch or oil ring groove 516 formed in said second end 514 to accommodate the presence of an oil ring (not shown). Body portion 510 may be formed of any material commonly known in the art to be used for pistons and piston components such as aluminum, etc., and is shaped and sized to be inserted into bore 51.

First end 512 is further comprised of a relatively flat surface or an opening 513 formed therein for receipt of fastener 520. Fastener 520 may be in the shape of a pin or may be a threaded fastener, such as a set screw. Opening 513 may be threaded or unthreaded to correspond to the shape, size and configuration of fastener 520. More specifically, when retention device 500 is placed in bore 51, fastener 520 may be inserted or threaded into both opening 54 in piston 50 and opening 513 in first end 512 of piston pin retention device 500 to prevent rotation of body portion 510 in bore 51 of piston 50. In this manner, unwanted rotation of device 500 can be prevented, and the oil ring (not shown) is permitted to function as originally intended, thereby prolonging its useful life as well as the useful life of piston 50.

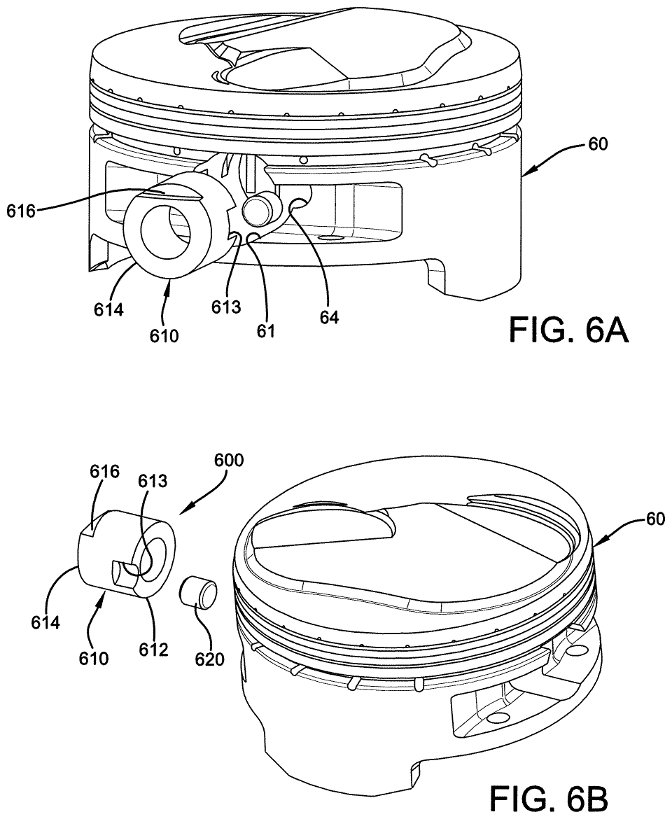

FIGS. 6A and 6B are perspective and partially exploded views of a piston 60 and an alternative embodiment of a piston pin retention device 600 of the present invention. Piston 60 can be any piston commonly known in the art having a bore 61, but further comprising a key opening or groove 64, the purpose of which is described more fully below.

Piston pin retention device 600 comprises a body portion 610 and a key 620. Body portion 610 is generally cylindrical in shape and comprised of a first end 612, a second end 614, and a notch or oil ring groove 616 formed in said second end 614 to accommodate the presence of an oil ring (not shown). Body portion 610 may be formed of any material commonly known in the art to be used for pistons and piston components such as aluminum, etc., and is generally sized to fit at least partially into bore 61.

First end 612 is further comprised of a key opening 613 formed therein for receipt of key 620. Key 620 may be in the shape of any key known in the art, such as a woodruff key, and should correspond in both shape and size to both key opening 613 and key groove 64. More specifically, when piston pin retention device 600 is placed in bore 61, key 620 is engaged with both key opening 613 and key groove 64 to prevent rotation of body portion 610 in bore 61 of piston 60. In this manner, unwanted rotation of device 600 can be prevented, and the oil ring (not shown) is permitted to function as originally intended and its useful life, as well as the useful life of piston 60, is extended.

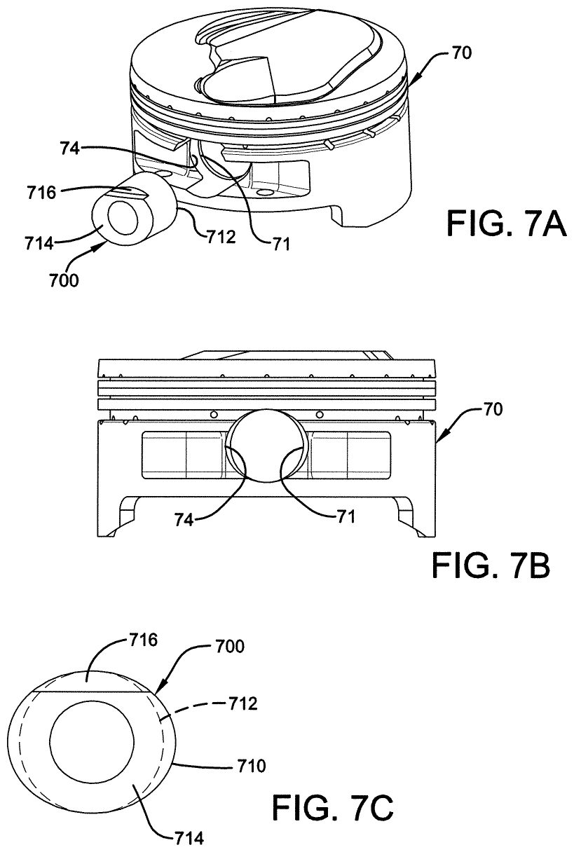

FIG. 7A is a perspective and partially exploded view of a piston 70 and an alternative embodiment of a piston pin retention device 700 of the present invention. Piston 70 can be any piston commonly known in the art having a bore 71, but further comprising an opening 74 axially aligned with said bore 71. Bore 71 is preferably generally cylindrical in shape, whereas opening 74 is preferably non-cylindrically shaped. For example, as best shown in FIG. 7B, opening 74 may be generally oblong or oval shaped. Nonetheless, it is contemplated that opening 74 could be in the form of other shapes, provided that it prevents the unwanted rotation of device 700 in bore 71, as explained more fully below.

Piston pin retention device 700 comprises a body portion 710 that is further comprised of a first end 712, a second end 714, and a notch or oil ring groove 716 formed in said second end 714 to accommodate the presence of an oil ring (not shown). Body portion 710 may be formed of any material commonly known in the art to be used for pistons and piston components such as aluminum, etc. The first end 712 of body portion 710 is generally cylindrical in shape and sized to fit within bore 71. By comparison, second end 714 is non-cylindrical and may be oblong as best shown in FIG. 7C, so as to matingly engage with opening 74 and prevent unwanted rotation of first end 712 of body portion 710 in bore 71.

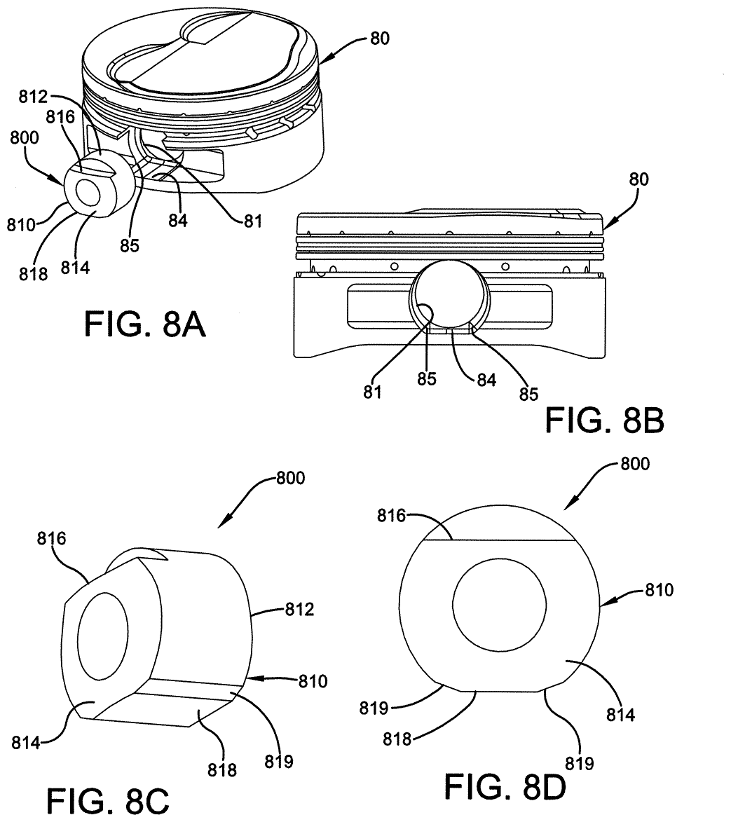

FIG. 8A is a perspective and partially exploded view of a piston 80 and a further alternative embodiment of a piston pin retention device 800 of the present invention. Piston 80 can be any piston commonly known in the art having a bore 81, but further comprising a surface 84 extending outwardly from bore 81, as best shown in FIGS. 8A and 8B.

More specifically, FIG. 8B is a front elevational view of the piston device 80 of FIG. 8A ready to receive the piston pin retention device 800 depicted in FIGS. 8A, 8C and 8D. Bore 81 is preferably generally cylindrical in shape, whereas surface 84 is not generally circular in shape and may be generally flat (or some other shape) and may further comprise a radius 85 positioned on one or both sides of surface 84. Nonetheless, it is contemplated that surface 84 and radii 85 could be in the form of other shapes or positioned elsewhere relative to bore 81, provided that the same prevent the unwanted rotation of device 800 in bore 81, as explained more fully below.

FIG. 8C is a perspective view of the piston pin retention device 800 of FIG. 8A, and FIG. 8D is a front elevational view of the piston pin retention device 800. Piston pin retention device 800 comprises a body portion 810 that is further comprised of a first end 812, a second end 814, and a notch or oil ring groove 816 formed in said second end 814 to accommodate the presence of an oil ring (not shown). Body portion 810 may be formed of any material commonly known in the art to be used for pistons and piston components such as aluminum, etc. Body portion 810 is generally cylindrical in shape and sized to fit within bore 81, with the exception of a generally flat or planar and non-cylindrical surface 818 on the bottom of body portion 810 that extends from the first end 812 to the second end 814 for engagement with flat surface 84 to prevent unwanted rotation of first end 812 of body portion 810 within bore 81. Notwithstanding, it is also contemplated that bore 81 and body portion 810 could be in the form of other non-cylindrical shapes provided that they correspond to one another, and do not permit unwanted rotation of first end 812 of body portion 810 within bore 81. For example, it is contemplated that bore 81 and body portion 810 could be in the form of geometric and non-geometric shapes.

As best shown in FIGS. 8C and 8D, body portion 810 may further comprise a radius or chamfered surface 819 positioned on one or both sides of, and immediately adjacent to, flat surface 818. Similar to planar surface 181, radius or chamfered surface(s) 819 also preferably extend from first end 812 to second end 814.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A piston pin retention button device for use with a piston having a generally cylindrical bore with a surface extending therefrom, comprising:
a body portion comprised of a cylindrical portion for mating engagement with said cylindrical bore and a non-cylindrical portion for mating engagement with the surface.

2. The piston pin retention button device of claim 1, wherein the non-cylindrical portion is planar.

3. The piston pin retention button device of claim 1, wherein the body portion further comprises a first end and a second end.

4. The piston pin retention button device of claim 3, wherein the non-cylindrical portion extends from the first end to the second end.

5. The piston pin retention button device of claim 1, wherein the mating engagement of the non-cylindrical portion with the surface prevents the rotation of the body portion within said cylindrical bore.

6. The piston pin retention button device of claim 1, wherein said body portion further comprises an oil ring groove.

7. The piston pin retention button device of claim 3, wherein the body portion further comprises at least one chamfer or radius.

8. The piston pin retention button device of claim 7, wherein the at least one chamfer or radius extends from the first end to the second end.

9. The piston pin retention button device of claim 1, wherein the body portion further comprises a first chamfer and a second chamfer.

10. The piston pin retention button device of claim 9, wherein each of the first and second chamfer are positioned adjacent to the non-cylindrical portion.

11. The piston pin retention button device of claim 9, wherein the non-cylindrical portion is positioned between the first chamfer and the second chamfer.

12. A piston pin retention button device for use with a piston having a generally cylindrical bore with a first surface extending therefrom, comprising:
a body portion comprised of
a cylindrical portion,
a second surface,
a first end, and
a second end.

13. The piston pin retention button device of claim 12, wherein the cylindrical portion and the second surface extend from the first end to the second end.

14. The piston pin retention button device of claim 12, wherein the mating engagement of the second surface of the device with the first surface of the piston prevents the rotation of the body portion within said cylindrical bore.

15. The piston pin retention button device of claim 12, wherein said body portion further comprises an oil ring groove.

16. The piston pin retention button device of claim 12, wherein the body portion further comprises at least one chamfer or radius.

17. The piston pin retention button device of claim 16, wherein the at least one chamfer or radius extends from the first end to the second end.

18. The piston pin retention button device of claim 12, wherein the body portion further comprises a first chamfer and a second chamfer.

19. The piston pin retention button device of claim 18, wherein the second surface is positioned between the first chamfer and the second chamfer.

20. A piston pin retention button device for use with a piston and comprising:
a body comprised of
an elongated member,
a surface extending along at least a portion of the elongated member,
at least one chamfer or radius,
a first end,
a second end, and
an oil ring groove positioned at the second end, wherein the piston has an opening that can accommodate a shape of the body.
